(19) United States
(12) Patent Application Publication
(10) Pub. No.: US 2015/0127643 A1
(43) Pub. Date: May 7, 2015

(54) DIGITALLY DISPLAYING AND ORGANIZING PERSONAL MULTIMEDIA CONTENT

(71) Applicant: Dadoof Corporation, Pleasant Grove, UT (US)

(72) Inventors: Mathew A. Cohen, Pleasant Grove, UT (US); Joshua M. Cohen, Draper, UT (US); Robert O. Beishline, South Jordan, UT (US); Shelley M. Beishline, South Jordan, UT (US); Jonathan Luckett, Alexandria, VA (US); Jennifer Schaerer, Draper, UT (US); John Schmidt, San Juan Capistrano, CA (US); Shantel Goodman, Alexandria, VA (US)

(21) Appl. No.: 14/536,476

(22) Filed: Nov. 7, 2014

Related U.S. Application Data
(60) Provisional application No. 61/901,328, filed on Nov. 7, 2013.

(51) Int. Cl. G06F 17/30

(52) U.S. Cl. CPC G06F 17/30029
USPC 707/725

(57) ABSTRACT

An apparatus, system, method, and program product are disclosed for digitally displaying and organizing personal multimedia content. A content module is configured to receive content associated with a user. The content includes one of user-generated content and third-party generated content. The content also includes an associated user rating. A chronological module is configured to present the content on a chronological interface. The chronological interface has an adjustable time period. An organization module is configured to organize the presented content associated with a time period such that content with a higher user rating is more prominently presented than content with a lower user rating.

### CROSS-REFERENCES TO RELATED APPLICATIONS

This application claims the benefit of U.S. Provisional Patent Application No. 61/901,328 entitled “DIGITALLY DISPLAYING AND ORGANIZING PERSONAL MULTIMEDIA CONTENT” and filed on Nov. 7, 2013, for Mathew A. Cohen, which is incorporated herein by reference.

### FIELD

This invention relates to digital media and more particularly relates to displaying and organizing multimedia associated with a user.

### BACKGROUND

A user's personal, digital, multimedia content may be stored in a variety of places—on a home computer, a laptop, a smart phone, in the cloud, on a social media network, etc. It may be difficult to keep track of all of a user's photos, videos, documents, etc. if they are not all located in a central repository. Even then, it may be difficult to organize, display, or find multimedia content, especially if a user has amassed a large collection of multimedia content.

### SUMMARY

A method for digitally displaying and organizing personal multimedia content is disclosed. A system, program product, and apparatus also perform the functions of the method. In one embodiment, a method includes receiving content associated with a user. In certain embodiments, the content includes an associated user rating. The method, in a further embodiment, includes presenting the content on a chronological interface that has an adjustable time period. In some embodiments, the method includes organizing the presented content associated with a time period such that content with a higher user rating is more prominently presented than content with a lower user rating.

In one embodiment, the content comprises personal content featuring the user. The personal content may be associated with a time period on the chronological interface. In another embodiment, the content comprises context content that defines a context of a time period on the chronological interface. In one embodiment, the context content comprises one or more of current events, pop culture events, sporting events, and news events. In a further embodiment, the method includes prepopulating the chronological interface with content in response to user input related to one or more setup interview questions.

In certain embodiments, the method includes determining a rating for the content. In one embodiment, the content is displayed on the chronological interface as a function of the rating. In some embodiments, the method includes receiving auxiliary information associated with the content, which may describe one or more characteristics of the content. In certain embodiments, the auxiliary information is presented on the chronological interface alongside the associated content. In a further embodiment, the method includes receiving one or more responses to one or more interview questions for the content and associating the one or more responses with the content.

In one embodiment, the method includes sorting the chronological interface based on search input, which may include one or more of a person, a location, and a keyword. In some embodiments, the content is filtered to chronologically display content matching the search input. In certain embodiments, the method includes storing a used filter comprising one or more search criteria. The content, in some embodiments, is filtered as a function of a stored filter being selected by a user.

In one embodiment, the method includes focusing in on a time period of the chronological interface such that concealed content for the time period becomes visible on the storyline in response to enhancing a focus level on the time period. In certain embodiments, the concealed content has lower user ratings than user ratings for visible content. The method, in a further embodiment, includes sharing at least a portion of the chronological interface with a sharing recipient. The sharing recipient may be authorized to one or more of view and post content on the storyline. In certain embodiments, the method includes exporting at least a portion of the chronological interface.

An apparatus for digitally displaying and organizing personal multimedia content is disclosed. In one embodiment, an apparatus includes a content module configured to receive content associated with a user. In a further embodiment, an apparatus includes a chronological module configured to present the content on a chronological interface. In some embodiments, an apparatus includes an auxiliary module configured to present auxiliary information associated with the content on the chronological interface.

In certain embodiments, the content comprises personal content featuring the user. In one embodiment, the personal content is associated with a time period on the chronological interface. In some embodiments, the content comprises context content that defines a context of a time period on the chronological interface. In certain embodiments, the context content comprises one or more of current events, pop culture events, sporting events, and news events.

In one embodiment, an apparatus includes a prepopulating module configured to prepopulate the chronological interface with content in response to user input related to one or more setup interview questions. In a further embodiment, an apparatus includes a rating module configured to determine a rating for the content. In one embodiment, the content is displayed on the chronological interface as a function of the rating.

In certain embodiments, an apparatus includes an organization module configured to organize the presented content associated with a time period. In certain embodiments, content with a higher user rating is more prominently presented than content with a lower user rating. In another embodiment, the auxiliary information is presented on the chronological interface alongside the associated content. In some embodiments, the auxiliary information module is configured to receive one or more responses to one or more interview questions for the content. The one or more response may be associated with the content.

A program product for digitally displaying and organizing personal multimedia content is discloses. In one embodiment, a program product includes a computer readable storage medium storing machine readable code executable by a processor. In one embodiment, the executable code includes code to perform receiving content associated with a user, which may include user-generated content and/or third-party generated content. In certain embodiments, the content includes an associated user rating. The executable code, in a further embodiment, includes code to perform presenting the content on a chronological interface that has an adjustable time period. In some embodiments, the executable code includes code to perform organizing the presented content associated with a time period such that content with a higher user rating is more prominently presented than content with a lower user rating.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one embodiment of a system for digitally displaying and organizing personal multimedia content;

FIG. 2 is a schematic block diagram illustrating one embodiment of a module for digitally displaying and organizing personal multimedia content;

FIG. 3 is a schematic block diagram illustrating one embodiment of another module for digitally displaying and organizing personal multimedia content;

FIG. 4 illustrates one embodiment of a chronological interface for digitally displaying and organizing personal multimedia content;

FIG. 5 illustrates one embodiment of associating auxiliary information with personal multimedia content;

FIG. 6 illustrates one embodiment of adding external content to a storyline;

FIG. 7 is a schematic flow chart diagram illustrating one embodiment of a method for digitally displaying and organizing personal multimedia content; and

FIG. 8 is a schematic flow chart diagram illustrating one embodiment of another method for digitally displaying and organizing personal multimedia content.

### DETAILED DESCRIPTION

As will be appreciated by one skilled in the art in light of this disclosure, aspects of the present invention may be embodied as an apparatus, a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, C#, Objective-C, or the like, conventional procedural programming languages, such as the “C” programming language or the like, display languages such as HTML, CSS, XML, or the like, scripting programming languages such as JavaScript, PHP, Perl, Python, Go, or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Aspects of the present invention are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

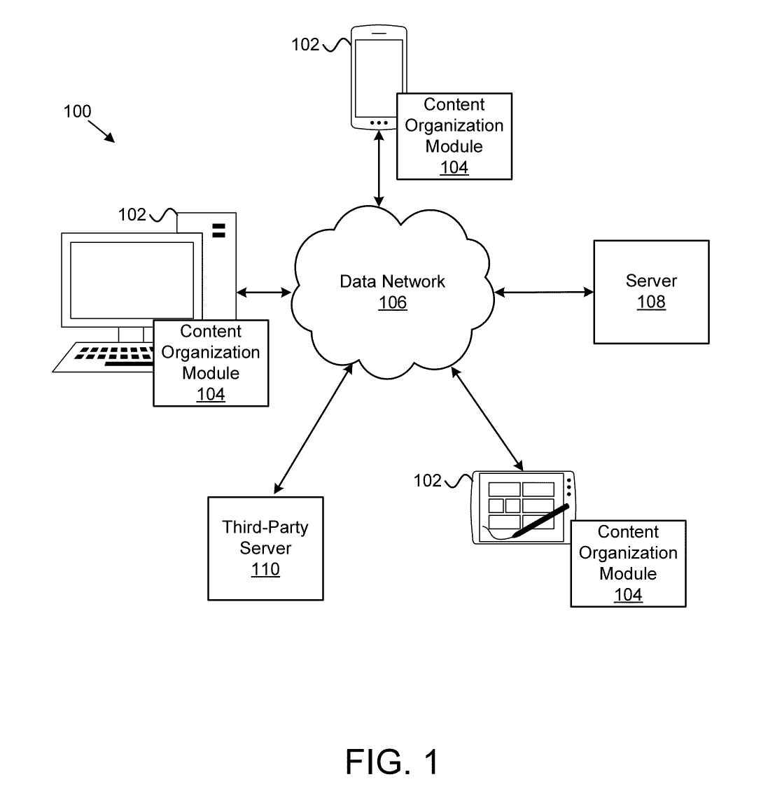

FIG. 1 depicts one embodiment of a system 100 for digitally displaying and organizing personal multimedia content. In one embodiment, the system 100 includes a plurality of information handling devices 102, one or more content organization modules 104, a network 106, a server 108, and a third-party server 110, which are described in more detail below.

In one embodiment, the system 100 includes a plurality of information handling devices 102. In certain embodiments, an information handling device 102 may include an electronic device comprising a processor and memory, such as a desktop computer, a laptop computer, a smart phone, a tablet computer, a smart TV, an eBook reader, a smart watch, an optical head-mounted display, and/or the like. In one embodiment, two or more information handling devices 102 are communicatively connected using the data network 106. In certain embodiments, the information handling devices 102 include a touch-enabled display, a physical keyboard, a microphone, a digital camera, and/or the like, which allows a user to interact with the information handling device 102.

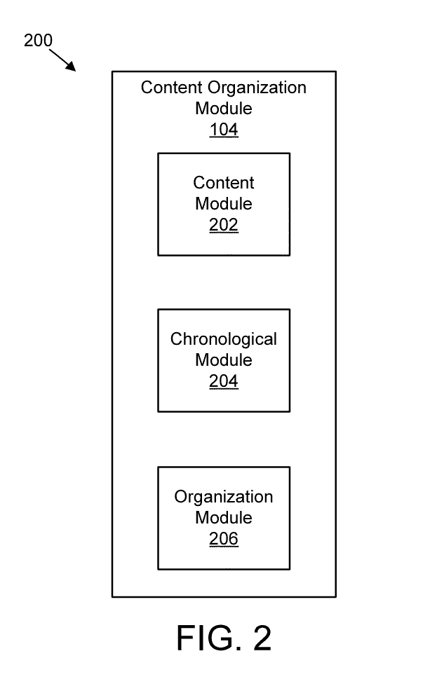

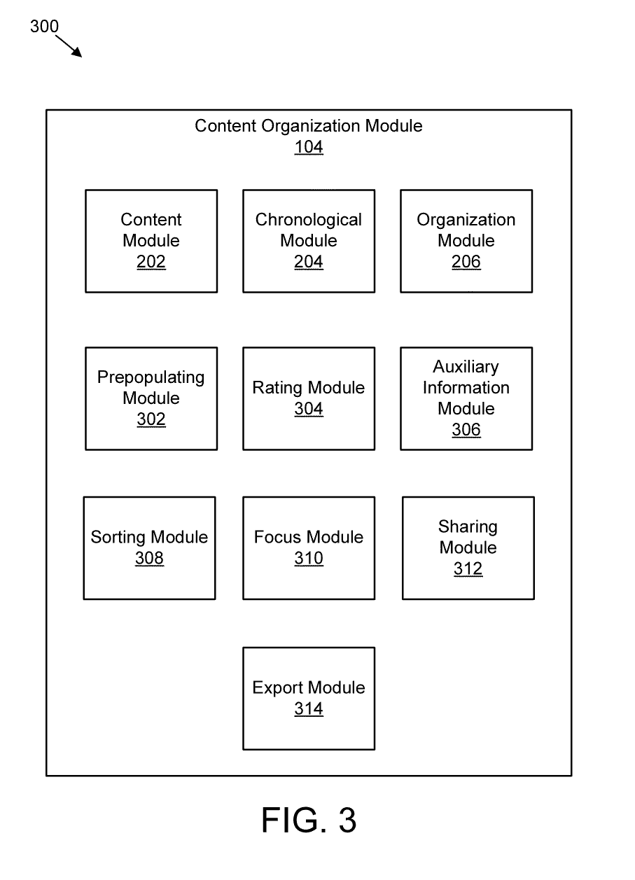

In one embodiment, the system 100 includes one or more content organization modules 104, which digitally display and organize personal multimedia content. In certain embodiments, the personal multimedia content is associated with a personal digital archive. In another embodiment, at least a portion of the content organization module 104 is located on an information handling device 102 and/or the server 108. In certain embodiments, the content organization module 104 includes a plurality of modules to perform the operations of receiving content associated with a user, presenting the content in a chronological interface, and organizing the presented content. The content organization module 104, and its associated modules, are described in more detail below with reference to FIGS. 2 and 3.

In some embodiments, the content organization module 104 is configured to receive content associated with a user. In various embodiments, the content includes user-generated content and third-party generated content. In one embodiment, the content includes an associated user rating. The content organization module 104, in further embodiments, is configured to present the content on a chronological interface, which includes an adjustable time period. The content organization module 104, in one embodiment, organizes the presented content associated with a time period according to the associated user rating. For example, content with a higher user rating may be more prominently presented than content with a lower user rating.

The content organization module 104, in one embodiment, is configured to present, aggregate, and organize various types of media content, such as videos, images, audio tracks, documents, webpages, or the like. The content organization module 104 may also associate auxiliary data or metadata with the multimedia content, such as ratings, reported feelings and/or emotions, other peoples' information, audio or video interviews, or the like. In this manner, the content organization module 104 may utilize the science of physiology of the human mind to combine facts with the sensations and emotions of a memory represented by the content presented on the chronological interface. Additionally, the content organization module 104 may utilize the science of communication so that the complete memory is communicated most effectively through vocabulary, sentence structure, recording of the sound to capture intonations, and video capturing for body language.

In order to recreate memories for a user, the content organization module 104 arranges and presents content in such a way as to effect two main parts of the brain responsible for memories: the posterior cortex and the hippocampus. The posterior cortex is considered the master mapmaker of our physical experience generating our perceptions of the outside world through the five senses of touch, hearing, sight, taste, and smell. The posterior cortex also keeps track of the location and movement of the physical body through touch and motion perception. The posterior cortex has the amazing adaptive perceptual functions of the back of the cortex to embed that object into in the neural body map.

The hippocampus is considered the master puzzle piece assembler in the brain. It links together widely separated pieces of information from our perceptions to a repository of facts and language, and then organizes and integrates the various neural messages. That integration is how moments are converted into memories. The hippocampus essentially links sensations, emotions, and thoughts, as well as facts and reflections, into a complete set of recollections. As described in more detail below, the content organization module 104 may arrange, present, and/or organize content and auxiliary data associated with the content to effect these basic forms of emotional and perceptual memory in order to trigger the brain to integrate the emotions and perceptions into factual and autobiographical recollections to lay the foundation for a memory.

In certain embodiments, the system 100 includes a data network 106. The data network 106, in one embodiment, is a digital communication network 106 that transmits digital communications related to digitally displaying and organizing personal multimedia content. The digital communication network 106 may include a wireless network, such as a wireless cellular network, a local wireless network, such as a Wi-Fi network, a Bluetooth® network, and the like. The digital communication network 106 may include a wide area network (“WAN”), a local area network (“LAN”), an optical fiber network, the internet, or other digital communication network. The digital communication network 106 may include two or more networks. The digital communication network 106 may include one or more servers, routers, switches, storage area networks (“SANs”), and/or other networking equipment. The digital communication network 106 may also include computer readable storage media, such as a hard disk drive, an optical drive, non-volatile memory, random access memory (“RAM”), or the like.

The system 100, in another embodiment, includes a server 108. The server 108, in some embodiments, includes a main frame computer, a desktop computer, a laptop computer, a cloud server, and/or the like. In certain embodiments, the server 108 includes at least a portion of the content organization module 104. In another embodiment, the information handling device 102 is communicatively coupled to the server 108 through the data network 106. The server 108, in a further embodiment, stores content associated with the personal digital archive, such as photos, videos, music, journal entries, documents, webpages, and/or the like, which is accessed by an information handling device 102 through the network 106. In certain embodiments, the information handling device 102 offloads at least a portion of the information processing associated with the content organization module 104, such as content sorting, content layout management, image processing, and/or the like, to the server 108.

In one embodiment, the system 100 includes a third-party server 110. The third-party server 110, in some embodiments, includes a main frame computer, a desktop computer, a laptop computer, a cloud server, and/or the like. The third-party server 110, in another embodiment, maintains and stores external content, such as websites, videos, images, text files, and/or the like, that may be accessed by the information handling devices 102 through the data network 106. The external content, as describe below, may be added to a user's storyline to become a part of the user's life story. Even though one third-party server 110 is depicted in FIG. 1, any number of third-party servers may be present and accessible through the data network 106.

FIG. 2 depicts one embodiment of a module 200 for digitally displaying and organizing personal multimedia content. In one embodiment, the module 200 includes a content organization module 104. The content organization module 104, in another embodiment, includes a content module 202, a chronological module 204, and an organization module 206, which are described below in more detail.

In one embodiment, the content organization module 104 includes a content module 202 configured to receive content associated with a user. In certain embodiments, a user includes an individual, entity, organization, and/or the like. The content, in some embodiments, includes multimedia content, such as digital photos, videos, audio files, and/or the like. In another embodiment, the content includes various digital documents, such as journal entries, text documents, PDF documents, and/or the like. In a further embodiment, the content is stored on the server 108 and is accessible by the content module 202 through the network 106. The content module 202 receives the content in response to user input, such as a request to view specific content. For example, in terms of the subject matter described herein, a user may request to view images of the featured user from a specified time period. In such an example, the content module 202 may receive images tagged with the specified time period from a server 108. In this manner, digital content associated with the user's life, i.e., content that describes the user's “story,” may be located in a central location on a server 108 known as a personal digital archive.

In certain embodiments, the content includes user-generated content and third-party generated content. In one embodiment, the content module 202 receives content uploaded by a user, such as personal photos, videos, journal entries, and/or the like, that feature the user. In some embodiments, the content module 202 assigns a permission level to the content based on user input. For example, a user may specify that a journal entry should be private, which may require a password, or other credentials, to access it. Alternatively, a user may specify that an image should be public, which would not require any additional credentials to access the content. In a further embodiment, the content module 202 assigns which friends, contacts, and/or the like associated with the user can access the content. A user, for example, may specify which friends can view an uploaded video.

The content module 202 may save uploaded content in a data store on a server 108, such as a database. In certain embodiments, if the content module 202 does not recognize the uploaded content as a valid content type, the content module 202 may reject the uploaded content. In another embodiment, the content module 202 receives user-generated content hosted on a third-party source, such as a social media website, a video hosting website, a photo sharing website, and/or the like. For example, the content module 202 may receive video content from YouTube® or photo content from Instagram® and incorporate the third-party hosted content into the user's storyline, as described below. Further, the content module 202 may link to the third-party content and display a link to the third-party hosted content on the user's storyline.

In another embodiment the content module 202 receives third-party generated content, such as news events, sporting events, political events, world events, pop culture events, and/or the like. For example, a user may upload and/or link to an article covering the Super Bowl, a presidential election, and/or the like for a particular year. Similarly, a user may incorporate content associated with their favorite band, sports team, celebrity, and/or the like. In this manner, the external content becomes a part of the user's storyline and helps tell the story of the user's life. In one embodiment, the third-party generated content is located on a third-party server 110. In a further embodiment, the content module 202 presents one or more external content items to a user based on previously presented content. For example, if the user uploaded content, such as photos and videos, related to soccer, the content module 202 may suggest different websites, articles, and/or the like, that are associated with soccer and that the user may want to incorporate into their storyline.

In certain embodiments, the content includes an associated user rating. In one embodiment, when the content is uploaded, the user may associate a rating with the content that defines the importance of the content. For example, a wedding photo, which may be a key event in a person's life, may be rated 5 out of 5. Alternatively, third-party generated content may be given a lower rating because it may not be directly related to the person's life. The content rating system, including assigning and modifying ratings to content, is described in detail below with reference to the rating module 304.

In another embodiment, the content organization module 104 includes a chronological module 204 configured to present the content on a chronological interface. The chronological interface, in some embodiments, is represented by a storyline, which may display content by time (such as a timeline), tag, people, keyword, event, and/or the like associated with a user in order to present the user's life story. In one embodiment, the storyline represents a single period of time. For example, the storyline may include content covering the entirety of a user's life, from birth to the present. In certain embodiments, the chronological module 204 subdivides the storyline into one or more adjustable time periods. For example, the storyline may be subdivided into different life events, such as graduations, weddings, children's birth dates, funerals, and/or the like. The chronological module 204, in one embodiment, adjusts the length of time of the time period associated with an event based on user input. Thus, a user may specify that certain content was from his seven years spent in college, and the chronological module 204 may create a subdivision on the storyline corresponding to the user's college years. In some embodiments, the chronological module 204 represents visual content using thumbnail images of the content, such as for images and videos. In another embodiment, the chronological module 204 represents other content, such as documents, journal entries, music files, and/or the like, with representative icons.

As described below with reference to FIG. 3, the chronological module 204 may perform various actions on the storyline, such as sorting content, zooming in on certain time periods, highlighting a particular time period, and/or the like. Moreover, the visual representation of the time periods presented on the storyline may be based on the displayed content, including the rating of the displayed content. Thus, one day on the storyline may occupy a large percentage of the visual area of the storyline if there are a number of highly-rated content items associated with that day. Conversely, one year on the storyline may occupy a small percentage of the visual area of the storyline based on the content rating associated with the content for that year. The chronological module 204, in certain embodiments, dynamically adjusts the visual area associated with a time period in response to new content associated with the time period being added to the storyline.

The content organization module 104, in one embodiment, includes an organization module 206 configured to organize the presented content associated with a time period. In another embodiment, the organization module 206 determines how to visually organize content associated with a specific time period. For example, if a specified time period includes a plurality of images associated with the time period, the organization module 206 may determine the best way to visually organize the images. In doing so, not all images may be visible at the same time in certain embodiments. The chronological module 204, in such an embodiment, determines which content to show, or otherwise make visible, and which content to hide, conceal, or the like.

In certain embodiments, the organization module 206 presents content with a higher user rating more prominently than content with a lower user rating. For example, a wedding photo with a 5 out of 5 rating may be represented by a larger thumbnail image on the storyline than a wedding photo from the same period with a 3 out of 5 user rating. Content that the organization module 206 hides or conceals, in one embodiment, becomes visible as a user focuses in on a particular time period, as described below with reference to the focus module 310.

In certain embodiment, the organization module 206 more prominently displays higher-rated content in response to a “scrubber bar,” which is similar to a scroll bar, being moved from one time period to another time period associated with the content. For example, in one embodiment, the thumbnail images representing the content in the storyline may be the same size. The same thumbnail images, however, may be made larger in response to the scrubber bar sliding across the storyline, either horizontally or vertically. As the scrubber bar moves across the storyline, images directly above (or to the side in a vertical storyline) are made larger; as the scrubber bar continues to move, those same images return to their original size. In this manner, the scrubber bar creates a magnification effect in order to make it easier to determine which content is more important (i.e., which content has high ratings).

FIG. 3 depicts one embodiment of another module 300 for digitally displaying and organizing personal multimedia content. In one embodiment, the module 300 includes a content organization module 104. The content organization module 104, in another embodiment, includes a content module 202, a chronological module 204, and an organization module 206, which are substantially similar to the content module 202, the chronological module 204, and the organization module 206 of FIG. 2. In a further embodiment, the content organization module 104 includes a prepopulating module 302, a rating module 304, an auxiliary information module 306, a sorting module 308, a focus module 310, a sharing module 312, and an export module 314, which are described in more detail below.

The content organization module 104, in one embodiment, includes a prepopulating module 302 configured to prepopulate the storyline with content based on a user's response to an initial interview question. Instead of being presented with a blank storyline the first time a user views the storyline, the prepopulating module 302 prepopulates the storyline with content based on information received from a user. In certain embodiments, the prepopulating module 302 prepopulates the storyline with content based on the demographic information associated with the user. For example, based on the user's age, the prepopulating module 302 may prepopulate the storyline with popular events associated with various milestones in the user's life, such as the user's birth date, toddler years, teenage years, college years, and/or the like. Alternatively, the prepopulating module 302 may prepopulate the storyline with popular events based on a predetermined time period, e.g., every year, every five years, and/or the like. The prepopulating module 302 may also prepopulate the storyline with major world events, such as the 9/11 attacks, walking on the moon, and/or the like, based on the demographic information of the user.

In another embodiment, the prepopulating module 302 receives responses to one or more interview questions before determining content to prepopulate the storyline with. For example, the prepopulating module 302 may ask the user informational questions, such as “What years were you in high school?,” “What years were you in college?,” “What college did you attend?,” “Where did you get married?,” “When was your first child born?,” and/or the like. Based on the responses to the interview questions, the prepopulating module 302 may add content to the storyline that is related to the response, the time period, and/or the like. For example, in response to the questions “What years did you attend high school? What high school did you attend?,” the prepopulating module 302 may add yearbook content for the time period and high school specified by the user. Similarly, in response to the question “What college did you attend?,” the prepopulating module 302 may incorporate events related to the user's college, such as sports events, images of the college's mascot and/or colors, and/or the like. At any time after prepopulating the storyline, the prepopulated content may be modified and/or updated by a user.

The interview questions presented by the prepopulating module 302, in certain embodiments, are text questions displayed on the storyline such that the user responds by typing an answer, checking a box, selecting a date from a drop down menu, and/or the like. In another embodiment, the interview questions are audible questions generated by the prepopulating module 302. The prepopulating module 302, in such an embodiment, receives voice responses from the users and performs speech-to-text and/or speech recognition to translate the voice responses into machine readable instructions. The prepopulating module 302 may also receive video responses from a user. For example, the user may record themselves using a webcam, or the like, responding to one or more presented interview questions.

In another embodiment, the content organization module 104 includes a rating module 304 configured to rate the content. For example, after an image is uploaded, the rating module 304 may assign a rating such as 4-stars, 5 out of 5, and/or the like to the image. In certain embodiments, the rating module 304 receives a content rating from a user when the user uploads content to the personal digital archive. In certain embodiments, as described above with reference to the organization module 206, the rating determines the presentation of the content on the storyline. For example, there may be one hundred images associated with a time period, such as a wedding. However, only a few of those images may be visible when the entire storyline is presented due to viewing area constraints. In order to determine which images to make visible, the organization module 206 may use the content rating. Thus, higher-rated content may be visible on the storyline, while lower-rated content is hidden. In order to view the hidden content, the storyline may be zoomed-in on the specific time period, which may trigger showing previously hidden content. Zooming-in on a specific time period is discussed below with reference to the focus module 310.

In certain embodiments, the content organization module 104 includes an auxiliary information module 306 configured to receive auxiliary information, e.g., metadata, associated with the content. In certain embodiments, the auxiliary information received by the auxiliary information module 306 describes the content. For example, the auxiliary information may include dates associated with the content, names, descriptions, titles, tags, and/or the like. In certain embodiments, the auxiliary information module 306 presents the auxiliary information on the storyline alongside the associated content.

In one embodiment, the auxiliary information module 306 receives auxiliary information in response to a user answering one or more interview questions related to the content. For example, after an image is received by the content module 2020, the auxiliary information module 306 may present various interview questions, such as “Who is in the photo?,” “Where was the photo taken?,” “When was the photo taken?,” and/or the like. As described above, the auxiliary information module 306 may receive responses entered by a user, spoken by a user, and/or video-taped by the user. The auxiliary information module 306, in certain embodiments, assigns the responses to the content, which may be displayed alongside the content on the storyline.

In another embodiment, the auxiliary information module 306 associates information with the content based on the substance of the content. For example, in one embodiment, the auxiliary information module 306 may perform facial recognition on an image in order to determine the people in the image. The auxiliary information module 306 may determine whether the people in the image are friends or contacts of the user and associates the content with those people. In another embodiment, the auxiliary information module 306, in response to recognizing one or more people in an image, may prompt the user to identify the people in the image. In response to the received responses, the auxiliary information module 306 may associate the content with the user and the people identified in the image.

In another embodiment, the auxiliary information module 306 receives metadata associated with the content as auxiliary information. For example, a video may be uploaded from a may have metadata that includes the date the video was shot, the location of the video (e.g., GPS location coordinates, or the like), and/or the like. In certain embodiments, the content module 202 receives content uploaded from a mobile device, such as a smart phone, which assigns metadata to the content. For example, an image taken on a vacation in Hawaii on July 7^{th} using a smart phone may be uploaded with metadata assigned by the smart phone, such as the GPS coordinates of the location of the image, the date the image was taken, and/or the like. The auxiliary information module 306, in certain embodiments, receives the metadata, parses the metadata, and associates the metadata with the content. The data derived from the metadata, as determined by the auxiliary information module 306, may define where the content is presented on the storyline. For example, parsing the date a video was taken from the metadata may assign that date to the video, which would be used to present the video on the storyline within a time period containing that date.

In certain embodiments, the chronological module 204 presents a map tracking the path of a user based on the auxiliary information associated with content. For example, content received from a vacation in Hawaii, such as a series of images, may be the basis for tracking the user's vacation through Hawaii. In particular, the chronological module 204 may use the date and location information assigned to the content by the auxiliary information module 306 to track the user's path through Hawaii during their vacation. In another embodiment, other auxiliary information is used to create the map, such as tags, user entered information, contextual information, and/or the like.

In some embodiments, the auxiliary information module 306 receives one or more tags from a user. A tag, as used herein, is a non-hierarchical keyword or term assigned to a piece of information, such as content presented on the storyline. The auxiliary information module 306 may assign one or more tags to content. For example, an image from a vacation in Hawaii may include the tags “Vacation 2010,” “Hawaii,” “Family fun,” and/or the like. In certain embodiments, the organization module 206 organizes content on the storyline according to different tags. Alternatively, content may be searched using one or more tags as keywords of the search. Tags, as with any auxiliary information, in one embodiment, may be entered by a user (e.g., on a keyboard) or may be spoken and recognized by the auxiliary information module 306 using speech recognition. In some embodiments, the auxiliary information module 306 assigns a “first time” tag to content identified as a “first time” the user did something. For example, the user may upload an image of the first time they rode a bike, flew on an airplane, attended a professional sporting event, and/or the like. In such an embodiment, the auxiliary information module 306 indicates “first time” content on the storyline with a “first time” icon.

The auxiliary information module 306, in another embodiment, prompts for meaningful information associated with the content. In certain embodiments, based on previously entered auxiliary information, the auxiliary information module 306 coaches a user to provide meaningful information, such as stories, reflections, memories, and/or the like, associated with the content. Thus, the auxiliary information module 306 may prompt a user to tell the story associated with an image from the user's vacation in Hawaii. The auxiliary information module 306, in certain embodiments, receives a voice recording of the meaningful information and associates the voice recording with the content. In this manner, the voice recording of a story associated with an image, for example, may be played along with the image in response to the image being clicked on the storyline. Alternatively, the auxiliary information module 306 may receive a text story, which may be entered on the storyline or uploaded to the storyline, and may display the story alongside the content in response to the content being interacted with on the storyline. In this manner, the user is able to tell or describe the story of his life using images, videos, and/or the like in addition to including voice recordings of memories, stories, reflections, and/or the like associated with the content.

In yet another embodiment, the content organization module 104 includes a sorting module 308 configured to sort the content presented on the storyline based on search input. In certain embodiments, the sorting module 308 receives search input comprising one or more of a person, a location, a keyword, a date, and/or the like. In certain embodiments, sorting module 308 filters the content presented on the storyline such that the storyline chronologically display content matching the search input. For example, the sorting module 308 may receive search input that includes a person's name, such as a contact associated with the user. The sorting module 308, based on the search input, may filter out content presented on the storyline that is not associated with the search input, i.e., does not include the person's name. Thus, content such as images, documents, journal entries, videos, or the like that do contain the search input remain chronologically presented on the storyline while other content that does not contain the search input is hidden.

In some embodiments, the sorting module 308 filters further within the search results. Thus, a user may provide a new search criteria to further search within the filtered storyline. The sorting module 308, in certain embodiments, also searches by content type, such as images, videos, journal entries, and/or the like to filter the storyline to display only specific types of content that contains the search input. For example, a user may search for “Hawaii” in images and videos, which would filter the storyline to only display images and videos that contain Hawaii, such as in a tag, description, and/or the like associated with the images and videos. In this manner, the sorting module 308 presents different stories on a user's storyline. For example, searching for “Hawaii” would filter the storyline to tell the “Hawaii” story. Similarly, searching for keywords such as “love,” “work,” “golf,” or the like filters the storyline to tell the user's “love” story, “work” story, “golf” story, or the like.

In certain embodiments, the sorting module 308 stores previously used storyline filters such that the filters may be used again in the future. For example, a “wedding” filter may be saved and used at a later time to quickly filter the storyline to only show content from a time period associated with a wedding, as define by a user. In some embodiments, the sorting module 308 creates one or more filters based on the stored filters. The sorting module 308 may present a list of chapters on the storyline, which may be selected to quickly filter the storyline based on previously used search criteria. In one embodiment, as described below with reference to the sharing module 312, the sharing module 312 shares chapters created by a user with one or more sharing recipients.

The content organization module 104, in some embodiments, includes a focus module 310 configured to focus in on a time period specified by a user. For example, an entire storyline may cover 40 years of a person's life, with different life events, milestones, or the like being presented on the storyline. As discussed above, content associated with an event that has a high rating may be more prominently displayed on the storyline than content with a lower rating. In some embodiments, content with a lower rating may not be visible at all when the entire storyline is displayed. In order to view hidden content, the focus module 310 may enhance a focus level, e.g., zoom in, on a specified time period in response to user input. Thus, a user with a 40 year storyline may specify a week (e.g., maybe a week corresponding to the user's wedding) to be visible on the storyline. In response to the user input, the focus module 310 zooms in on the requested week such that only content associated with that week is visible. Consequently, previously hidden (e.g., lower rated) content may now be visible on the storyline.

In some embodiments, the focus module 310 sets a focus level for the storyline. For example, focus level one may display the entire storyline, while larger focus level values may zoom further into the storyline. The focus module 310, in certain embodiments, can be set to zoom in on different time units, such as years, months, weeks, days, hours, minutes, and/or the like. For example, the focus module 310 may receive a request to zoom in on a specific wedding day. Further, the focus module 310 may receive a request to zoom in to a particular time range for that day, such as the hours covering the wedding ceremony, the wedding reception, or the like. As the focus module 310 zooms in, hidden content may become visible, while visible content not meeting the time period requested becomes hidden.

Moreover, after the focus module 310 zooms in on a particular time period, the sorting module 308 may filter the content associated with the time period based on received search criteria. Thus, after the focus module 310 zooms in on the hours representing the reception at a wedding, the sorting module 308 may receive search input comprising a person's name to filter the reception content to only content containing the person's name. Alternatively, the search module 308 may filter the content to a particular content type, such as images and/or videos of the reception. In some embodiments, the focus module 310 presents an icon on the storyline to indicate that there is hidden content that is not being shown, but that could be visible if zoomed in, for a particular time period and/or event.

In another embodiment, the content organization module 104 includes a sharing module 312 that is configured to share at least a portion of the storyline with a sharing recipient. In some embodiments, the sharing recipient is a friend or contact associated with the user and is authorized to view and/or post content on the user's storyline. The sharing module 312, in one embodiment, shares chapters created by the sorting module 308 with one or more sharing participants. For example, the sharing module 312 may share a “wedding” chapter created by the sorting module 308 with one or more sharing participants. The sharing module 312, in certain embodiments, shares a chapter by sending a link to a webpage that displays the chapter. The link may be sent by email, text message, instant message, and/or the like. Additionally, the link may be posted on a social media network associated with the user and/or the recipient.

In another embodiment, the sharing module 312 sets a limit on the number of people who may view the user's storyline. For example, the sharing module 312 may limit the number of the user's friends and/or contacts that may view the user's storyline to fifty. In some embodiments, the sharing module 312 limits who can view the user's storyline based on a degree of connectedness to the user. For example, the sharing module 312 may only allow contacts and/or friends that are within a first degree of connectedness (e.g., immediate family) to view the user's storyline.

In certain embodiments, the sharing module 312 determines the permissions associated with a recipient. In one embodiment, the recipient may only view the shared portion of the user's storyline. In another embodiment, the recipient may edit the shared portion of the user's storyline, such as, for example, adding content to the storyline, tagging themselves in a photo on the storyline, and/or the like. In certain embodiments, the sharing module 312 posts additions, deletions, and/or modifications to the user's storyline in response to the user approving the additions, deletions, and/or modifications. In some embodiments, the sharing module 312 inserts a received portion of a different user's storyline into the user's storyline. Thus, portions of two user's storylines may be in sync such that the users have parallel storylines, which together tell a more involved story involving two or more people where the story is told from different perspectives.

In some embodiments, the sharing module 312 finds content on other users' storylines and determines whether the content is relevant to the user's storyline. In such an embodiment, the sharing module 312 alerts the user to the content on the other users' storylines and verifies the user wants to add the content to his own storyline. Thus, for example, the sharing module 312 may find a wedding picture that a user's friend has added to his storyline and determines whether the user would like to add the picture to his own storyline. In some embodiments, the sharing module 312 obtains permission from the other user in order to access content on the other user's storyline.

The content organization module 104, in a further embodiment, includes an export module 314 configured to export at least a portion of the storyline, including all, or a portion of, the content presented on the storyline. In certain embodiments, the export module 314 exports the storyline to different formats, such as various image formats (e.g., jpg, png, gif, and/or the like), various document formats (e.g., doc, docx, odf, pdf, rtf, txt, and/or the like), various video formats (e.g., avi, m4v, mpeg, mp4, mov, and/or the like), various audio formats (e.g., mp3, way, ogg, wma, and/or the like), and/or the like. In another embodiment, the export module 314 exports the storyline, or a portion of the storyline, to different web pages, blog postings, social media platforms, image sharing sites, and/or the like.

Alternatively, the export module 314 exports the storyline to a printable format, such that the storyline may be printed and/or bound into a physical copy. In certain embodiments, the export module 314 connects to third-party printing sites, such as Shutterfly®, StoryRock, and/or the like, such that the storyline can be uploaded to the third-party printing site and prepared for printing.

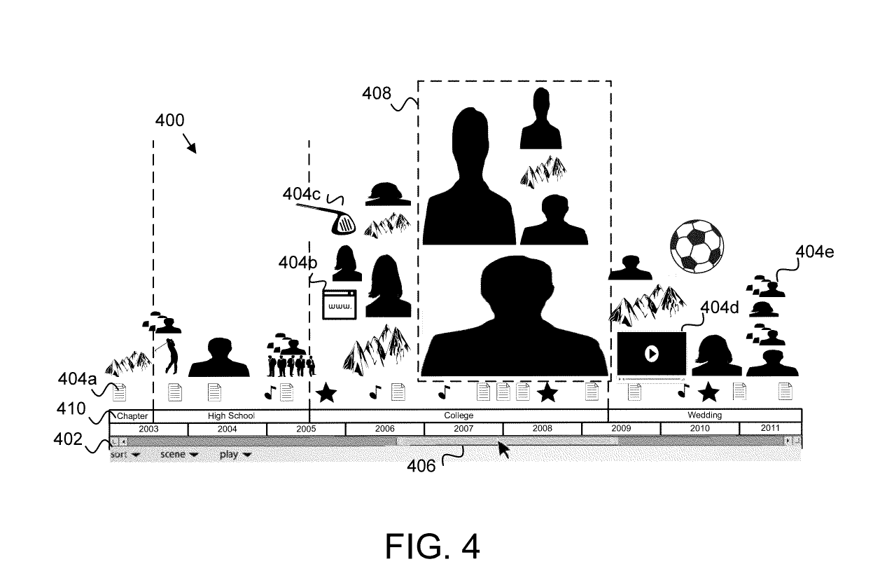

FIG. 4 depicts one embodiment of a chronological interface 400 for digitally displaying and organizing personal multimedia content. The chronological interface 400 includes a storyline 402 divided into a plurality of time periods. In certain embodiments, the chronological module 204 divides the storyline into one or more time periods. In the depicted embodiment, the storyline 402 is divided evenly divided into time periods that each represent one year.

The chronological module 204, in certain embodiments, presents various content elements on the storyline 402, which have been received by the content module 202. In the depicted embodiment, for example, the chronological module 204 may include icons 404a representing uploaded documents, journal entries, music files, “first time” events, milestone events, and/or the like. The chronological module 204, in another embodiment, includes external content 404b, which may include links to third-party generated content, such as news events, sports events, pop culture events, and/or the like. In a further embodiment, the chronological module 204 includes graphics 404c, videos 404d, and images 404e. In certain embodiments, if there are multiple hidden images for a certain time period, the image thumbnail 404e presented by the chronological module 204 appears to have images stacked behind it. This acts as a visual cue that there are more images for the time period and that they may need to focus in on the time period to see all the images.

The chronological interface 400, in another embodiment, includes a scrubber bar 406. In some embodiments, the scrubber bar 406 is presented by the organization module 206. In the depicted embodiment, the scrubber bar 406 may slide to the left and right to highlight a specific period of time. As the scrubber bar 406 is moved, content directly above the scrubber bar 406 is highlighted, meaning that the visual presentation of certain content elements may change. In the depicted embodiment, for example, the thumbnails 408 representing the content above the scrubber bar 406 is visually changed such that higher-rated content appears more prominent than lower-rated content. In this manner, a user can easily and quickly see which content associated with a time period is more important.

The chronological interface 400 also includes, in some embodiments, one or more chapters 410 representing a custom time period. For example, a college chapter may include all the content uploaded during the college time period, as defined by the user. In certain embodiments, the sorting module 308 creates a chapter 410 based on search/filter criteria entered by a user. Content may be associated with a chapter 410, in another embodiment, based on auxiliary data associated with the content, including tags, dates, descriptions, and/or the like. Thus, uploaded content with a “college” tag may be associated with the college chapter.

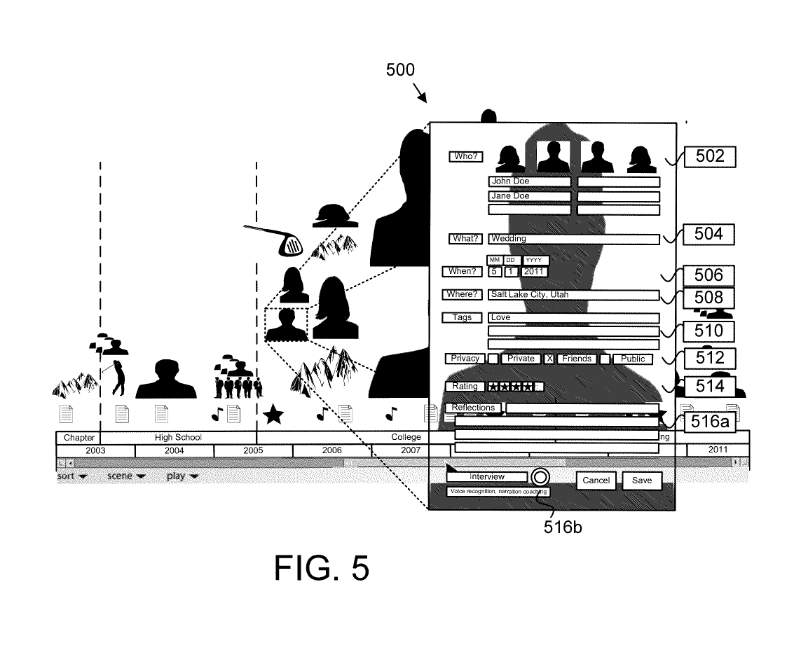

FIG. 5 depicts one embodiment of an interface 500 for providing auxiliary information associated with a content element. The interface 500, in certain embodiments, is presented by the auxiliary information module 306. The auxiliary information module 306 may present the interface in response to new content being uploaded or already uploaded content being modified. In some embodiments, the interface 500 presents one or more fields 502-516a for the user to enter auxiliary information about the content. The types of fields presented in the interface 500 may be dependent on the type of content. For example, images may have different auxiliary information fields than a video.

In the depicted embodiment, the interface 500 includes a “Who?” field 502 where a user can specify other people associated with the content. In some embodiments where the content is an image, the auxiliary information module 306 may perform facial recognition and display one or more pictures of persons that are likely to be in the image, which the user can then select.

In a further embodiment, the interface 500 includes a “What?” field 504 where the user can describe the content. The interface 500 may also include a “When?” field 506 where the user can enter the date of the content, such as the date a video was shot. In some embodiments, the auxiliary information module 306 derives the date of the content from metadata associated with the content. In another embodiment, the interface 500 includes a “Where?” field 508 where the user can specify the location of the content. Again, the auxiliary information module 306 may derive the location from metadata associated with the content.

The interface 500, in another embodiment, provides a “Tags” field 510 where the user can assign one or more tags to the content. In certain embodiments, the tags may be used by the sorting module 308 to create various filters, chapters, and/or the like based on search criteria entered by the user. In a further embodiment, the interface 500 includes a “Privacy” field 512 where the user can specify the accessibility level of the content, such as private, public, friends only, and/or the like. In another embodiment, the user may specify a rating 514 associated with the content, which determines the importance of the content. In one embodiment, the rating module 304 receives the rating 514 from the user. The rating 514, in another embodiment, may be used by the organization module 206 to determine which content to make visible on the storyline.

The interface 500 also provides a field 516a where a user can enter more meaningful information associated with the content, such as reflections, memories, stories and/or the like. Alternatively, the interface 500 interviews 516b the user by asking the user a number of questions regarding the content and receiving spoken answers from the user, which may be processed using speech recognition. In certain embodiments, the auxiliary information module 306 presents the interview questions to the user. In some embodiments, the interview process coaches a user through telling their story associated with the content by prompting the user with specific questions related to the content.

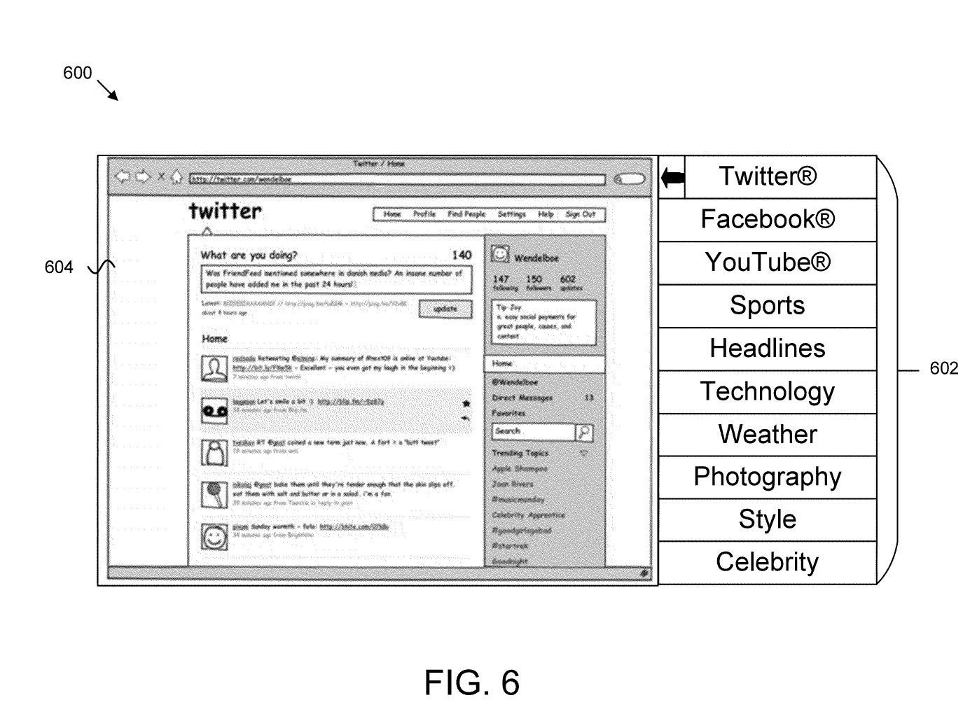

FIG. 6 depicts an embodiment of an interface 600 for adding external content to the storyline. In one embodiment, the external content includes third-party generated content, which may be stored on a third-party server 110. In one embodiment, the interface 600 presents one or more categories 602 that a user can select to browse external content. In some embodiments, the content module 202 presents the subject matter of the categories 602 based on previously uploaded content. For example, in the depicted embodiment, the content module 202 may present a “Twitter®” category, which may display content 604 associated with the user's Twitter® account in response to the user having a plurality of Twitter®-related content on their storyline. Other categories 620 may be standard, such as social networking platforms, news content, sports content, weather, pop culture, and/or the like.

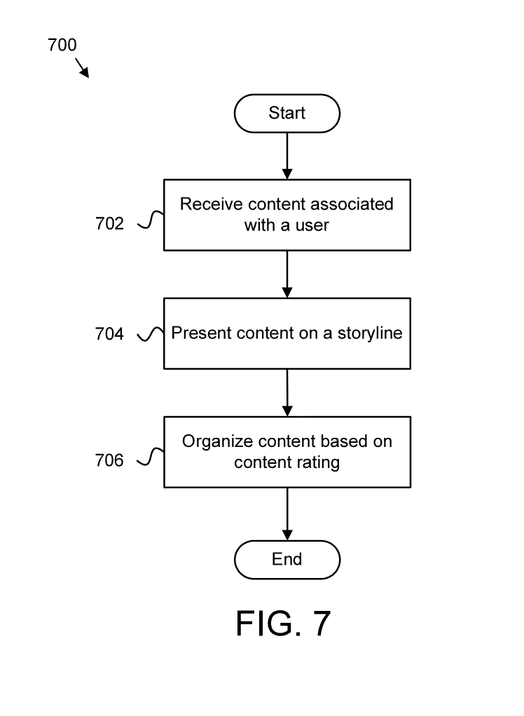

FIG. 7 depicts one embodiment of a method 700 for digitally displaying and organizing personal multimedia content. In one embodiment, the method 700 begins and a content module 202 receives 702 content associated with a user. In certain embodiments, the content module 202 receives 702 user-generated content and third-party generated content. The content module 202, in a further embodiment, receives 702 content uploaded by a user. In another embodiment, the content module 202 receives 702 content hosted on a third-party source, such as a social media site, video sharing site, photo sharing site, and/or the like. In some embodiments, the content includes an associated user rating that defines the importance of the content in relation to other content.

In another embodiment, a chronological module 204 presents 704 content on a storyline. The chronological module 204, in certain embodiments, subdivides the storyline into one or more time periods. In some embodiments, based on user input, the chronological module 204 adjusts the length of time of each time period. In another embodiment, an organization module 206 organizes 706 the presented content associated with a time period. The organization module 206, in certain embodiments, determines the most appropriate way to present content on the storyline based on a rating associated with the storyline. For example, an image with a higher rating than a video may be more prominently displayed than the video. And the method 700 ends.

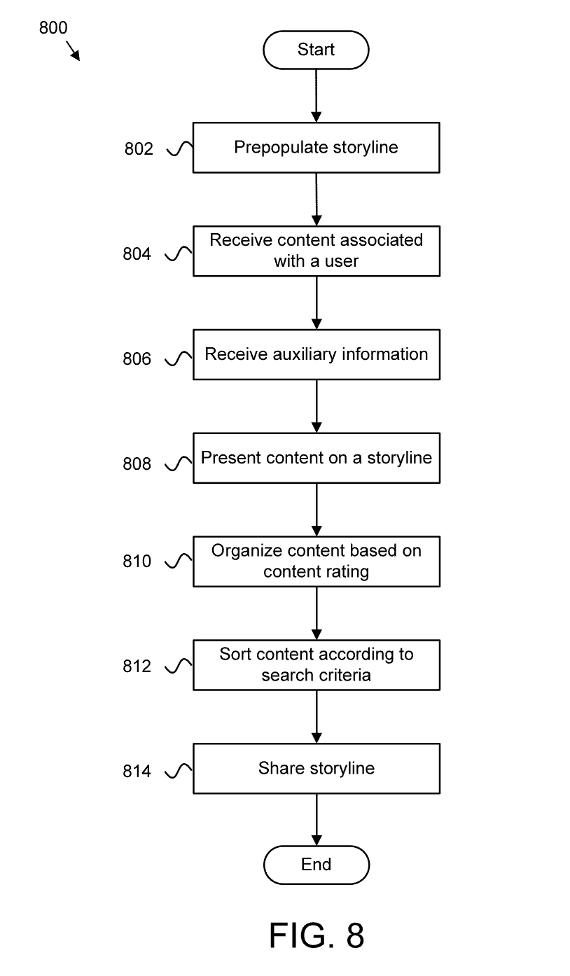

FIG. 8 depicts another embodiment of a method 800 for digitally displaying and organizing personal multimedia content. In one embodiment, the method 800 begins and a prepopulating module 302 prepopulates 802 the storyline with content based on a user's responses to initial interview questions. In certain embodiments, the prepopulating module 302 prepopulates 802 the storyline with content based on the demographic information associated with the user. For example, based on the user's age, the prepopulating module 302 may prepopulate 802 the storyline with popular events associated with various milestones in the user's life, such as the user's birth date, toddler years, teenage years, college years, and/or the like. In another embodiment, the prepopulating module 302 receives responses to one or more interview questions before determining content to prepopulate 802 the storyline with. For example, the prepopulating module 302 may ask the user informational questions, such as “What years were you in high school?,” “What years were you in college?,” “What college did you attend?,” “Where did you get married?,” When was your first child born?,” and/or the like. Based on the responses to the interview questions, the prepopulating module 302 may add content to the storyline related to the responses.

In another embodiment, a content module 202 receives 804 content associated with a user, including both user-generated and third-party generated content. In some embodiments, an auxiliary information module 306 receives 806 auxiliary information associated with the content such as dates associated with the content, names, descriptions, titles, tags, and/or the like. In certain embodiments, the auxiliary information module 306 presents the auxiliary information on the storyline alongside the associated content. In one embodiment, the auxiliary information module 306 receives 806 auxiliary information in response to a user answering one or more interview questions related to the content. For example, after an image is received by the content module 202, the auxiliary information module 306 may present various interview questions, such as “Who is in the photo?,” Where was the photo taken?,” “When was the photo taken?,” and/or the like. In another embodiment, the auxiliary information module 306 receives 806 metadata associated with the content as auxiliary information. For example, a video may be uploaded from a may have metadata that includes the date the video was shot, the location of the video (e.g., GPS location coordinates, or the like), and/or the like.

In one embodiment, a chronological module 204 presents 808 content on a storyline. The chronological module 204, in certain embodiments, subdivides the storyline into one or more time periods. In a further embodiment, an organization module 204 organizes 810 the presented content associated with a time period. In another embodiment, the organization module 206 determines the most appropriate way to present content on the storyline based on a rating associated with the storyline. For example, an image with a higher rating than a video may be more prominently displayed than the video.

In a further embodiment, a sorting module 308 sorts 812 the content presented on the storyline based on search criteria. In certain embodiments, the sorting module 308 receives search input comprising one or more of a person, a location, a keyword, a date, and/or the like. For example, the sorting module 308 may receive a search input that includes a person's name, such as a contact associated with the user. The sorting module 308, based on the search input, may filter out content presented on the storyline that is not associated with the search input, i.e., does not include the person's name. Thus, content such as images, documents, journal entries, videos, or the like that do contain the search input remain chronologically presented on the storyline while other content that does not contain the search input is hidden. The sorting module 308, in certain embodiments, searches by content type, such as images, videos, journal entries, and/or the like to filter the storyline to display only specific types of content that contains the search input. For example, a user may search for “Hawaii” in images and videos, which would filter the storyline to only display images and videos that contain Hawaii, such as in a tag, description, and/or the like associated with the images and videos. In certain embodiments, the sorting module 308 stores previously used storyline filters such that the filters may be used again in the future. For example, a “wedding” filter may be saved and used at a later time to quickly filter the storyline to only show content from a time period associated with a wedding, as define by a user.

In certain embodiments, the sharing module 312 shares 814 at least a portion of the storyline with a sharing recipient. In some embodiments, the sharing recipient is a friend or contact associated with the user and is authorized to view and/or post content on the user's storyline. The sharing module 312, in one embodiment, shares 814 chapters created by the sorting module 308 with one or more sharing participants. For example, the sharing module 312 may share 814 a “wedding” chapter created by the sorting module 308 with one or more sharing participants. In another embodiment, the sharing module 312 sets a limit on the number of people who may view the user's storyline. In some embodiments, the sharing module 312 finds content on other users' storylines and determines whether the content is relevant to the user's storyline. In such an embodiment, the sharing module 312 alerts the user to the content on the other users' storylines and verifies the user wants to add the content to his own storyline. And the method 800 end.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving content associated with a user, the content comprising an associated user rating;
presenting the content on a chronological interface, the chronological interface having an adjustable time period; and
organizing the presented content associated with a time period, wherein content with a higher user rating is more prominently presented than content with a lower user rating.

2. The method of claim 1, wherein the content comprises personal content featuring the user, the personal content associated with a time period on the chronological interface.

3. The method of claim 1, wherein the content comprises context content, the context content defining a context of a time period on the chronological interface, wherein the context content comprises one or more of current events, pop culture events, sporting events, and news events.

4. The method of claim 1, further comprising prepopulating the chronological interface with content in response to user input related to one or more setup interview questions.

5. The method of claim 1, further comprising determining a rating for the content, the content being displayed on the chronological interface as a function of the rating.

6. The method of claim 1, further comprising receiving auxiliary information associated with the content, the auxiliary information describing one or more characteristics of the content, wherein the auxiliary information is presented on the chronological interface alongside the associated content.

7. The method of claim 1, further comprising receiving one or more responses to one or more interview questions for the content, the one or more responses being associated with the content.

8. The method of claim 1, further comprising sorting the chronological interface based on search input, the search input comprising one or more of a person, a location, and a keyword, wherein the content is filtered to chronologically display content matching the search input.

9. The method of claim 8, further comprising storing a used filter comprising one or more search criteria, wherein the content is filtered as a function of a stored filter being selected by a user.

10. The method of claim 1, further comprising focusing in on a time period of the chronological interface, wherein concealed content for the time period becomes visible on the storyline in response to enhancing a focus level on the time period, the concealed content having lower user ratings than user ratings for visible content.

11. The method of claim 1, further comprising sharing at least a portion of the chronological interface with a sharing recipient, the sharing recipient being authorized to one or more of view and post content on the storyline.

12. The method of claim 1, further comprising exporting at least a portion of the chronological interface.

13. An apparatus comprising:
a content module configured to receive content associated with a user;
a chronological module configured to present the content on a chronological interface; and
an auxiliary module configured to present auxiliary information associated with the content on the chronological interface.

14. The apparatus of claim 13, wherein the content comprises personal content featuring the user, the personal content associated with a time period on the chronological interface.

15. The apparatus of claim 13, wherein the content comprises context content, the context content defining a context of a time period on the chronological interface, wherein the context content comprises one or more of current events, pop culture events, sporting events, and news events.

16. The apparatus of claim 13, further comprising a prepopulating module configured to prepopulate the chronological interface with content in response to user input related to one or more setup interview questions.

17. The apparatus of claim 13, further comprising a rating module configured to determine a rating for the content, the content being displayed on the chronological interface as a function of the rating.

18. The apparatus of claim 13, further comprising an organization module configured to organize the presented content associated with a time period, wherein content with a higher user rating is more prominently presented than content with a lower user rating.

19. The apparatus of claim 13, wherein the auxiliary information module is further configured to receive one or more responses to one or more interview questions associated with the content.

20. A program product comprising a computer readable storage medium storing machine readable code executable by a processor, the executable code comprising code to perform:
receiving content associated with a user, the content comprising one of user-generated content and third-party generated content, the content comprising an associated user rating;
presenting the content on a chronological interface, the chronological interface having an adjustable time period; and
organizing the presented content associated with a time period, wherein content with a higher user rating is more prominently presented than content with a lower user rating.
